(19) United States
(12) Patent Application Publication
(10) Pub. No.: US 2024/0215108 A1
(43) Pub. Date: Jun. 27, 2024

(54) RESOURCE ALLOCATION OF LOW POWER SIGNALS

(71) Applicant: Samsung Electronics Co., Ltd., Suwon-si (KR)

(72) Inventor: Hongbo Si, Allen, TX (US)

(21) Appl. No.: 18/536,068

(22) Filed: Dec. 11, 2023

Related U.S. Application Data
(60) Provisional application No. 63/434,677, filed on Dec. 22, 2022.

(51) Int. Cl. H04W 76/28; H04L 5/00

(52) U.S. Cl. CPC H04W 76/28; H04L 5/0053

(57) ABSTRACT

Apparatuses and methods for resource allocation of low power signals. A method of a user equipment (UE) in a wireless communication system includes receiving a first configuration for a discontinuous reception (DRX) of a low power signal; determining, based on the first configuration for the DRX, a duration of an ON period associated with the DRX, a cycle period within which the ON period periodically occurs in time, and a number of monitoring occasions for the low power signal within the ON period; and receiving the low power signal based on the monitoring occasions for the low power signal.

### CROSS-REFERENCE TO RELATED AND CLAIM OF PRIORITY

The present application claims priority under 35 U.S.C. § 119(e) to: U.S. Provisional Patent Application No. 63/434,677 filed on Dec. 22, 2022, which is hereby incorporated by reference in its entirety.

### TECHNICAL FIELD

The present disclosure relates generally to wireless communication systems and, more specifically, the present disclosure is related to apparatuses and methods for resource allocation of low power signals.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to resource allocation of low power signals.

In an embodiment, a user equipment (UE) in a wireless communication system is provided. The UE includes a transceiver configured to receive a first configuration for a discontinuous reception (DRX) of a low power signal and a processor operably coupled to the transceiver. The processor is configured to determine, based on the first configuration for the DRX, a duration of an ON period associated with the DRX, a cycle period within which the ON period periodically occurs in time, and a number of monitoring occasions for the low power signal within the ON period. The transceiver is further configured to receive the low power signal based on the monitoring occasions for the low power signal.

In another embodiment, a base station (BS) in a wireless communication system is provided. The BS includes a processor configured to determine a first configuration for a DRX of a low power signal. The first configuration includes a duration of an ON period associated with the DRX, a cycle period within which the ON period periodically occurs in time, and a number of monitoring occasions for the low power signal within the ON period. The BS further includes a transceiver operably coupled to the processor. The transceiver is configured to transmit the first configuration for the DRX of the low power signal and transmit the low power signal based on the first configuration.

In yet another embodiment, a method of a UE in a wireless communication system is provided. The method includes receiving a first configuration for a DRX of a low power signal; determining, based on the first configuration for the DRX, a duration of an ON period associated with the DRX, a cycle period within which the ON period periodically occurs in time, and a number of monitoring occasions for the low power signal within the ON period; and receiving the low power signal based on the monitoring occasions for the low power signal.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIG. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates a diagram of multiplexing in the frequency domain according to embodiments of the present disclosure;

FIG. 7 illustrates a timeline of time domain resource for the low power signal(s) according to embodiments of the present disclosure; and

FIG. 8 illustrates a flowchart of an example UE procedure for the low power signal(s) according to embodiments of the present disclosure.

### DETAILED DESCRIPTION

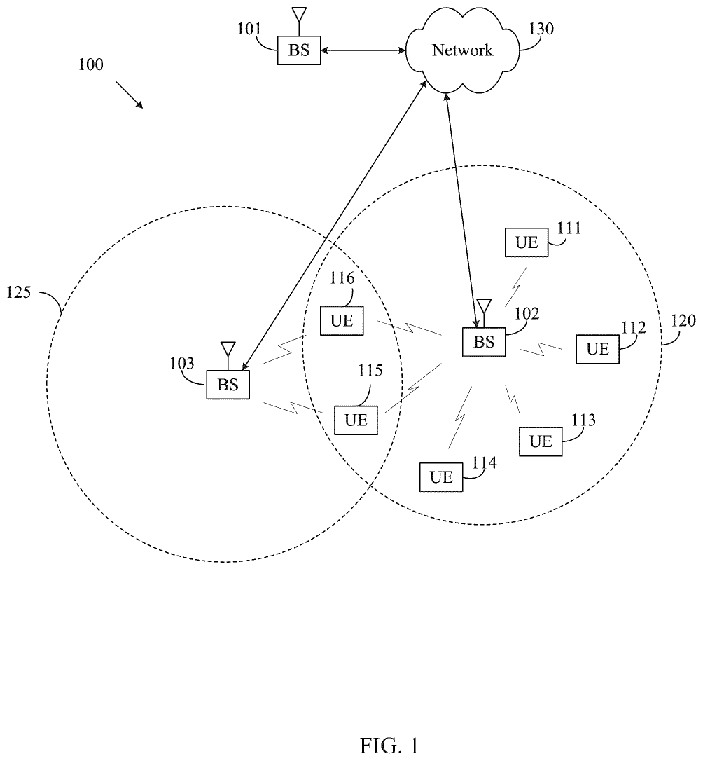

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v17.1.0, “NR; Physical channels and modulation;” [2] 3GPP TS 38.212 v17.1.0, “NR; Multiplexing and channel coding;” [3] 3GPP TS 38.213 v17.1.0, “NR; Physical layer procedures for control;” [4] 3GPP TS 38.214 v17.1.0, “NR; Physical layer procedures for data;” and [5] 3GPP TS 38.331 v17.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying and utilizing a resource allocation of low power signals. In certain embodiments, one or more of the BSs 101-103 include circuitry, programing, or a combination thereof to support resource allocation of low power signals.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

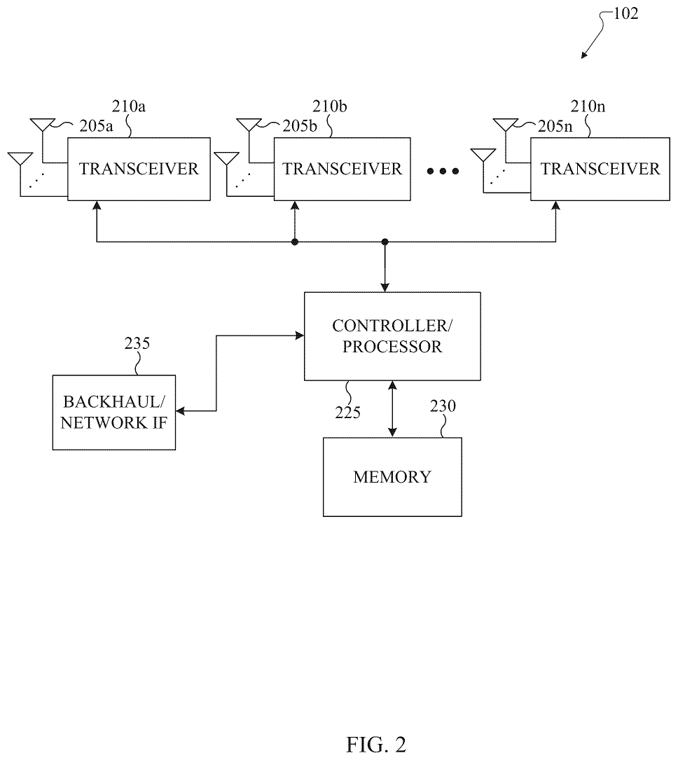

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods to support resource allocation of low power signals. Any of a wide variety of other functions could be supported in the gNB 102 by the controller/processor 225.

The controller/processor 225 is also capable of executing programs and other processes resident in the memory 230, such as processes to support resource allocation of low power signals. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

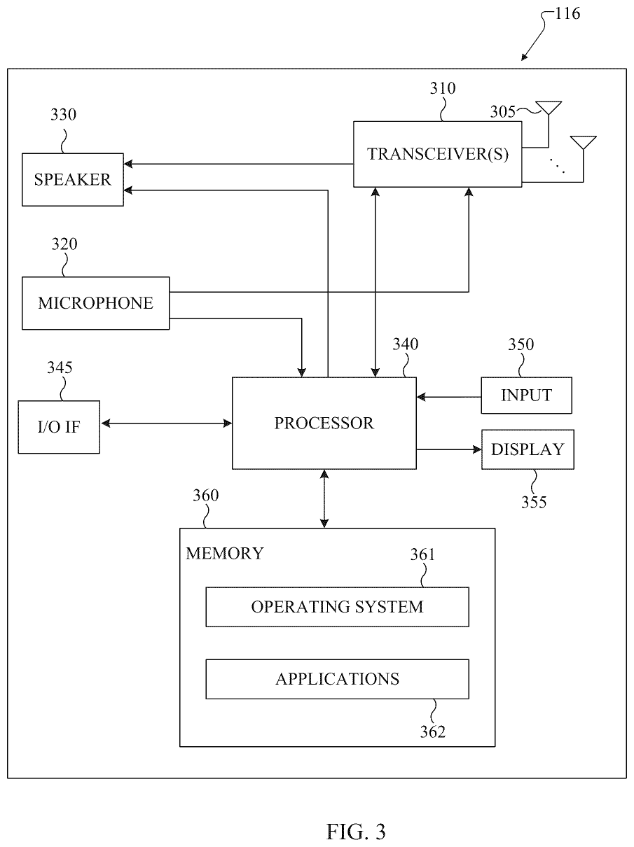

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to identify and utilize resource allocation of low power signals as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

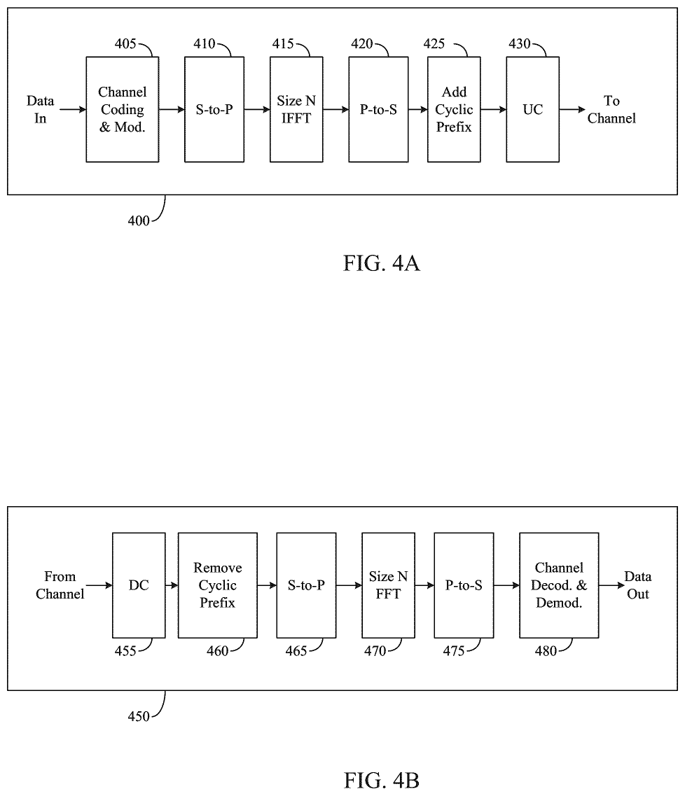

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured for receiving low power signals according to a resource allocation as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

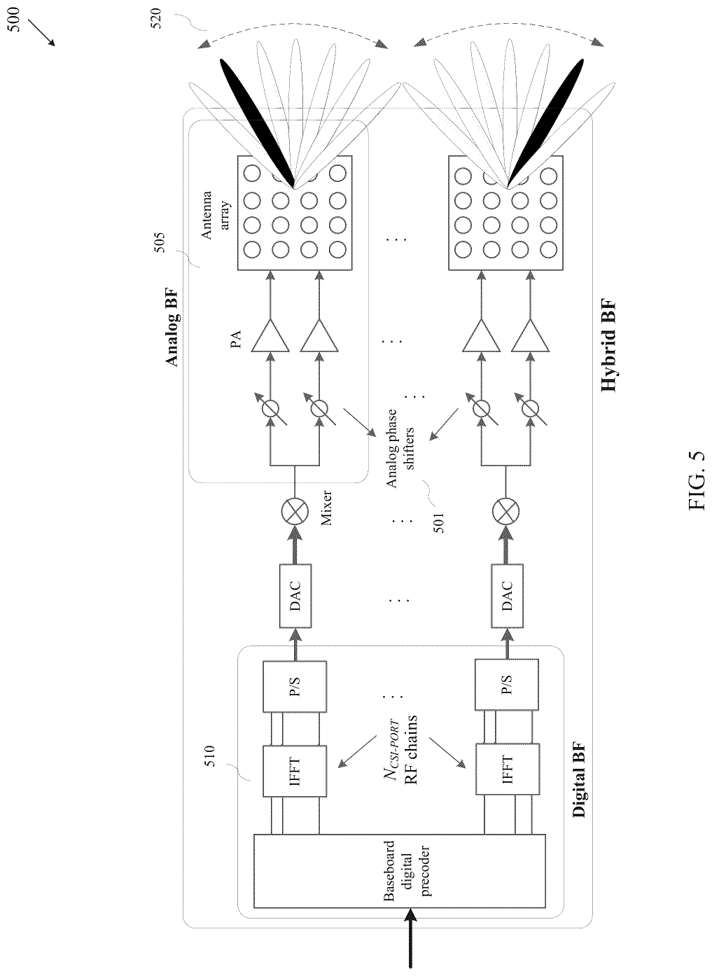

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 channel state information reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/ digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are necessary to compensate for the additional path loss.

NR supported discontinuous reception (DRX) for a UE in either RRC_IDLE/RRC_INACTIVE mode or RRC_CONNECTED mode, such that the UE could stop receiving signals or channels during the inactive period within the DRX cycle and save power consumption. In Rel-16, enhancement towards DRX for RRC_CONNECTED mode (e.g., C-DRX) was introduced, wherein a new downlink control information (DCI) format was used to help the UE to skip a ON duration within a C-DRX cycle such that further power saving gain could be achieved. In Rel-17, enhancement towards DRX for RRC_IDLE/RRC_INACTIVE mode (e.g., I-DRX) was introduced, wherein a paging early indication (PEI) was used for a UE to skip monitoring paging occasions such that extra power saving gain could be achieved.

However, the UE still demands to frequently wake up to monitor the new DCI format or the PEI, such that the radio of the UE cannot be fully turned off for a long duration. Embodiments of the present disclosure recognize to avoid such situation and to acquire further power saving gain, an additional receiver radio is evaluated, wherein the additional receiver radio can be used to monitor a particular set of signals with very low power consumption, and the main receiver radio can be turned off or operating with a very lower power for a long duration.

The present disclosure focuses on the resource allocation for the low power signals that could be received by the additional receiver radio, wherein the low power signals can be implemented with a waveform to enable low power reception at the additional receiver radio.

When low power signal(s) includes multiple types of signals, each type of the signal can be according to examples in the present disclosure jointly or separately.

The present disclosure focuses on the resource allocation for the low power signal(s). More precisely, the following aspects are included in the present disclosure:
Frequency domain resources for the low power signal(s);
Frequency domain multiplexing between the low power signal(s) and other signal/channel;
Time domain resources for the low power signal(s);
Time domain multiplexing between the low power signal(s) and other signal/channel;
Power domain resources for the low power signal(s); and
Example UE procedure for resource allocation of the low power signal(s).

In one embodiment, frequency domain resources for the low power signal(s) (e.g., LP-WUS) can include at least one of the following aspects.

In one aspect, the frequency domain resources for the low power signal(s) includes a bandwidth part (BWP) for the low power signal(s), e.g., determined as a BWP that the low power signal(s) is confined within.

For one example, the BWP for the low power signal(s) can be the active DL BWP configured to the UE 116.

For another example, the BWP for the low power signal(s) can be initial DL BWP, e.g., when the UE 116 is in the RRC_IDLE and/or RRC_INACTIVE mode.

For yet another example, the BWP for the low power signal(s) can be a separated and dedicated BWP provided to the UE 116 for receiving the low power signal(s). For instance, the gNB 102 can provide the UE 116 a set of configurations for a BWP dedicated for receiving the low power signal(s). For another instance, the BWP dedicated for receiving the low power signal(s) can be with the same bandwidth as the low power signal(s). For yet another instance, the BWP dedicated for receiving the low power signal(s) can be with the same bandwidth as the low power signal(s) and the associated guard band(s).

In another aspect, the frequency domain resources for the low power signal(s) includes a subcarrier spacing of the low power signal.

For one example, the subcarrier spacing for the low power signal can be the same as the BWP for the low power signal.

For another example, the subcarrier spacing for the low power signal can be fixed, e.g., per frequency range and/or per band.

For yet another example, the subcarrier spacing for the low power signal can be configured by higher layer parameters. For one instance, the subcarrier spacing for the low power signal can be provided by system information (e.g., system information block 1, SIB1, or system information block X, SIBX, where X>1). For another instance, the subcarrier spacing for the low power signal can be provided by dedicated RRC parameter and/or a system information block.

In another aspect, the frequency domain resources for the low power signal(s) includes a frequency location of the low power signal(s), e.g., determined based on a frequency location of a first subcarrier within the subcarriers or a first resource block (RB) within the RBs that the low power signal(s) is mapped to (e.g., potentially including the guard band of the low power signal(s)).

For one example, the frequency location of the low power signal(s) can be fixed. For one instance, the frequency location can be fixed per frequency range and/or per band. For another instance, the frequency location can be fixed with respect to the BWP and/or bandwidth for the low power signal(s) (e.g., a fixed number of subcarrier or RB comparing to the starting subcarrier or RB of the BWP and/or bandwidth).

For another example, the frequency location of the low power signal(s) can be configured by higher layer parameters. For one instance, the frequency location for the low power signal can be provided by system information (e.g., system information block 1, SIB1, or system information block X, SIBX, where X>1). For another instance, the frequency location for the low power signal can be provided by dedicated RRC parameter. For one instance, the frequency location can be an absolute frequency location, e.g., by using an absolute radio frequency channel number (ARFCN). For another instance, the frequency location can be a RB index number, e.g., comparing to the starting common RB, or comparing to the starting RB of the BWP. For yet another instance, the frequency location can be a subcarrier index number, e.g., comparing to the starting common RB, or comparing to the starting RB of the BWP, or comparing to the starting subcarrier of the first RB in the bandwidth for the low power signal(s).

For yet another example, the frequency location of the low power signal(s) can be determined based on a predefined set of frequency locations. For one instance, the set of frequency locations can be with uniform intervals and defined as a set of raster entries for the low power signal(s). For another instance, the set of frequency locations can be defined based on absolute radio frequency channel number (ARFCN).

In yet another aspect, the frequency domain resources for the low power signal(s) include a bandwidth of the low power signal(s), e.g., determined based on a span from a first subcarrier to a last subcarrier or from a first RB to a last RB, in the frequency domain for the low power signal(s) or determined based on a number of subcarriers or RBs including the low power signal(s) and the associated guard band(s).

In one example, the number of subcarriers or RBs for the low power signal(s) (e.g., potentially including the associated guard band(s)) can be fixed. In another example, the number of subcarriers or RBs for the low power signal(s) (e.g., potentially including the associated guard band(s)) can be scaled based on the subcarrier spacing, such that the absolute value of the bandwidth (e.g., as MHz) is fixed. For instance, when the subcarrier spacing is 15*2^μ kHz, the number of subcarriers or RBs for the low power signal(s) can be Y/2^μ, wherein Y is the number of subcarriers or RBs for the low power signal(s) with 15 kHz subcarrier spacing.

In another example, the number of subcarriers or RBs for the low power signal(s) can be configured by higher layer parameters. For one instance, the bandwidth of the low power signal can be provided by system information (e.g., system information block 1, SIB1, or system information block X, SIBX, where X>1). For another instance, the bandwidth of the low power signal can be provided by dedicated RRC parameter.

In yet another aspect, the frequency domain resources for the low power signal(s) include a density of the low power signal(s), e.g., determined based on an interval between neighboring subcarriers or RBs mapped for the low power signal(s).

In one example, the density of the low power signal(s) can be fixed. For one instance, the interval between neighboring subcarriers mapped for the low power signal(s) can be fixed as 1, e.g., the low power signal(s) is mapped to a number of contiguous subcarriers in the frequency domain. For another instance, the interval between neighboring subcarriers mapped for the low power signal(s) can be fixed as 3, e.g., within each RB, 4 subcarriers distributed uniformly are mapped for the low power signal(s). For yet another instance, the interval between neighboring subcarriers mapped for the low power signal(s) can be fixed as 4, e.g., within each RB, 3 subcarriers distributed uniformly are mapped for the low power signal(s).

In another example, the density of the low power signal(s) can be configured by higher layer parameters. For one instance, the density of the low power signal can be provided by system information (e.g., system information block 1, SIB1, or system information block X, SIBX, where X>1). For another instance, the density of the low power signal can be provided by dedicated RRC parameter.

In yet another aspect, the frequency domain resources for the low power signal(s) includes a guard band for the low power signal(s), e.g., determined based on a number of subcarriers or a number of RBs located on either or both side of the low power signal(s) or located between different blocks of the low power signal(s), such that no other transmission is performed within the number of subcarriers or RBs (e.g., mapped to a value of 0).

In one example, at least one of the guard band(s) for the low power signal(s) can be fixed. For instance, a fixed number of subcarriers or RBs are used on either or both side of the low power signal(s). For one sub-instance, the guard band(s) can be 1 RB on either or both side of the low power signal(s). For another sub-instance, the guard band(s) can be 2 RBs on either or both side of the low power signal(s).

In another example, the size of at least one of the guard band(s) for the low power signal(s) can be configured by higher layer parameters. For one instance, the size of the guard band for the low power signal can be provided by system information (e.g., system information block 1, SIB1, or system information block X, SIBX, where X>1). For another instance, the size of the guard band for the low power signal can be provided by dedicated RRC parameter.

In yet another example, the size of at least one of guard band for the low power signal(s) can be a UE capability or part of a UE capability and reported to the gNB 102.

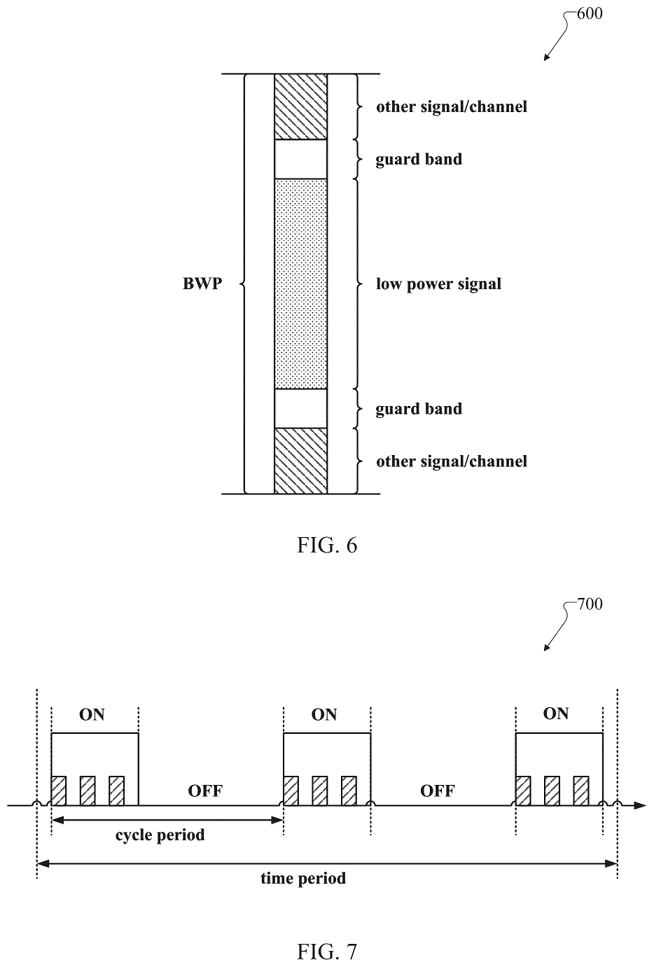

FIG. 6 illustrates a diagram 600 of multiplexing in the frequency domain according to embodiments of the present disclosure. For example, diagram 600 of multiplexing in the frequency domain can be utilized by the UE 116 of FIG. 3. This example is for illustration only and other embodiments can be used without departing from the scope of the present disclosure.

In one embodiment, the low power signal(s) can be multiplexed with other signal or channel in the frequency domain, e.g., within the same OFDM symbol(s). For instance, for an OFDM symbol including the low power signal(s), other signal or channel can be mapped to subcarriers or RBs in the same OFDM symbol that are not mapped for the low power signal, potentially with a guard band between the low power signal and the other signal or channel.

In one example, the multiplexing of other signal or channel can be allowed only when the other signal or channel is located in the lower frequency to the low power signal.

In another example, the multiplexing of other signal or channel can be allowed only when the other signal or channel is located in the higher frequency to the low power signal.

In yet another example, the multiplexing of other signal or channel can be allowed only when the other signal or channel is located either in the lower frequency or in the higher frequency to the low power signal. For one instance, whether it is located in the lower frequency or in the higher frequency can be configured to the UE 116. For another instance, whether it is located in the lower frequency or in the higher frequency can be subject to a UE capability.

In yet another example, the multiplexing of other signal or channel can be allowed when the other signal or channel is located in the lower frequency and/or in the higher frequency to the low power signal. For one instance, whether it is located on both lower frequency and higher frequency or located on either lower frequency or higher frequency can be configured to the UE 116. For another instance, whether it is located on both lower frequency and higher frequency or located on either lower frequency or higher frequency can be subject to a UE capability.

In one example, the type of signal or channel that can be multiplexed with the low power signal(s) in the frequency domain (e.g., FDMed in the same OFDM symbol(s)) can be limited to a particular set of types of signal or channel, e.g., only some type of signal or channel can be multiplexed with the low power signal(s).
For one instance, physical downlink shared channel (PDSCH) can be multiplexed with the low power signal(s) in the frequency domain (e.g., FDMed in the same OFDM symbol(s)), e.g., PDSCH can rate match around the resources for the low power signal(s).
For another instance, synchronization signal/physical broadcast channels (SS/PBCH) block can be multiplexed with the low power signal(s) in the frequency domain (e.g., FDMed in the same OFDM symbol(s)).
For yet another instance, physical downlink control channel (PDCCH) can be multiplexed with the low power signal(s) in the frequency domain (e.g., FDMed in the same OFDM symbol(s)).
For yet another instance, CSI-RS can be multiplexed with the low power signal(s) in the frequency domain (e.g., FDMed in the same OFDM symbol(s)).
For yet another instance, positioning reference signal (PRS) can be multiplexed with the low power signal(s) in the frequency domain (e.g., FDMed in the same OFDM symbol(s)).

In another example, the type of signal or channel that can be multiplexed with the low power signal(s) in the frequency domain (e.g., FDMed in the same OFDM symbol(s)) can be limited to a particular set of types of signal or channel, e.g., some type of signal or channel cannot be multiplexed with the low power signal(s).
For one instance, PDSCH cannot be multiplexed with the low power signal(s) in the frequency domain (e.g., FDMed in the same OFDM symbol(s)), e.g., PDSCH cannot rate match around the resources for the low power signal(s) and the resource allocation of PDSCH shall avoid OFDM symbols mapped for the low power signal(s).
For another instance, SS/PBCH block cannot be multiplexed with the low power signal(s) in the frequency domain (e.g., FDMed in the same OFDM symbol(s)).
For yet another instance, PDCCH cannot be multiplexed with the low power signal(s) in the frequency domain (e.g., FDMed in the same OFDM symbol(s)).
For yet another instance, CSI-RS cannot be multiplexed with the low power signal(s) in the frequency domain (e.g., FDMed in the same OFDM symbol(s)).
For yet another instance, PRS cannot be multiplexed with the low power signal(s) in the frequency domain (e.g., FDMed in the same OFDM symbol(s)).

In one example, when a UE expects to receive other DL signal or channel and low power signal(s), wherein at least one RE for the other DL signal or channel overlaps with at least one RE of the time domain resources and/or frequency domain resources for the low power signal(s) (e.g., overlapping in a same RB within a same OFDM symbol), the UE 116 can drop the reception of the low power signal(s).
For one instance, the other DL signal or channel can be a PDSCH.
For another instance, the other DL signal or channel can be a SS/PBCH block.
For yet another instance, the other DL signal or channel can be a PDCCH. For one sub-instance, the PDCCH can be monitored in a Type0-PDCCH CSS set.
For yet another instance, the other DL signal or channel can be a CSI-RS.
For yet another instance, the other DL signal or channel can be a PRS.

In another example, when a UE expects to receive other DL signal or channel and low power signal(s), wherein at least one RE for the other DL signal or channel overlaps with at least one RE of the time domain resources and/or frequency domain resources for the low power signal(s) (e.g., overlapping in a same RB within a same OFDM symbol, the UE 116 can drop the reception of other DL signal or channel.
For one instance, the other DL signal or channel can be a PDSCH.
For another instance, the other DL signal or channel can be a SS/PBCH block.
For yet another instance, the other DL signal or channel can be a PDCCH. For one sub-instance, the PDCCH can be monitored in a Type0-PDCCH CSS set.
For yet another instance, the other DL signal or channel can be a CSI-RS.
For yet another instance, the other DL signal or channel can be a PRS.

In yet another example, when a UE expects to receive other DL signal or channel, the UE 116 can expect that no REs for receiving the other DL signal or channel overlap with the REs of the time domain resources and/or frequency domain resources for the low power signal(s)).
For one instance, the other DL signal or channel can be a PDSCH.
For another instance, the other DL signal or channel can be a SS/PBCH block.
For yet another instance, the other DL signal or channel can be a PDCCH. For one sub-instance, the PDCCH can be monitored in a Type0-PDCCH CSS set.
For yet another instance, the other DL signal or channel can be a CSI-RS.
For yet another instance, the other DL signal or channel can be a PRS.

In another embodiment, the low power signal(s) cannot be multiplexed with other signal or channel in the frequency domain. For instance, for an OFDM symbol including the low power signal(s), other signal or channel cannot be mapped to subcarriers or RBs in the same OFDM symbol that are not mapped for the low power signal, e.g., the OFDM symbol can be used for low power signal(s) only.

In one example, when a UE expects to receive other DL signal or channel and low power signal(s) in a same OFDM symbol, the UE 116 can drop the reception of the low power signal(s).
For one instance, the other DL signal or channel can be a PDSCH.
For another instance, the other DL signal or channel can be a SS/PBCH block.
For yet another instance, the other DL signal or channel can be a PDCCH. For one sub-instance, the PDCCH can be monitored in a Type0-PDCCH CSS set.
For yet another instance, the other DL signal or channel can be a CSI-RS.
For yet another instance, the other DL signal or channel can be a PRS.

In another example, when a UE expects to receive other DL signal or channel and low power signal(s) in a same OFDM symbol, the UE 116 can drop the reception of other DL signal or channel.
For one instance, the other DL signal or channel can be a PDSCH.
For another instance, the other DL signal or channel can be a SS/PBCH block.
For yet another instance, the other DL signal or channel can be a PDCCH. For one sub-instance, the PDCCH can be monitored in a Type0-PDCCH CSS set.
For yet another instance, the other DL signal or channel can be a CSI-RS.
For yet another instance, the other DL signal or channel can be a PRS.

In one embodiment, time domain resources for the low power signal(s) (e.g., LP-WUS) can include at least one of the following aspects.

FIG. 7 illustrates a timeline 700 of time domain resource for the low power signal(s) according to embodiments of the present disclosure. For example, timeline 700 for the low power signals can be utilized by the UE 116 of FIG. 3. This example is for illustration only and other embodiments can be used without departing from the scope of the present disclosure.

In one aspect, the time domain resources for the low power signal(s) can include a DRX cycle configuration. The reception of the low power signal(s) or part of the low power signal(s) can be confined within a time domain window (e.g., a ON period), wherein the time domain window can periodically occur or semi-statically occur in a time period, with a cycle period (e.g., period between the start of two neighboring time domain windows). In each time domain window, there can be one or multiple reception occasions for the low power signal.

For one example, the cycle period can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For another example, the cycle period can be determined based on a duty cycle of paging DRX (e.g., using the main receiver) in RRC_IDLE and/or RRC_INACTIVE mode. For instance, the cycle period can be the same as the duty cycle of paging DRX in RRC_IDLE and/or RRC_INACTIVE mode. For another instance, the cycle period can be an integer multiple number of the duty cycle of paging DRX in RRC_IDLE and/or RRC_INACTIVE mode (e.g., the integer multiple number can be provided by higher layer parameter, which can be either system information block or dedicated RRC parameter).

For yet another example, the cycle period can be determined based on a duty cycle of UE DRX (e.g., using the main receiver) in RRC_CONNECTED mode. For instance, the cycle period can be the same as the duty cycle of UE DRX in RRC_CONNECTED mode. For another instance, the cycle period can be an integer multiple number of the duty cycle of UE DRX in RRC_CONNECTED mode (e.g., the integer multiple number can be provided by higher layer parameter, which can be dedicated RRC parameter).

For yet another example, a duration of the time domain window (e.g., the duration of the ON period) can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter. For one instance, when the duration of the time domain window is configurable, at least a value same as the cycle period can be supported, such that the UE performs continuous monitoring of the low power signal(s).

For yet another example, a duration of the time domain window can be fixed. For one instance, the duration of the time domain window can be same as the duration of the low power signal(s) such that each time domain window includes a single reception occasion for the low power signal(s). For another instance, the duration of the time domain window can be same as an integer multiple of the duration of the low power signal(s) such that each time domain window includes a number of reception occasions for the low power signal(s).

For yet another example, a duration of the time domain window (e.g., the duration of the ON period) can be determined as a number of reception occasions for the low power signal(s). For one instance, the number of reception occasions can be configured, e.g., by a higher layer parameter. For instance, the higher layer parameter can be system information (e.g., system information block 1, SIB1, or system information block X, SIBX, where X>1).

For yet another example, an offset to start the time domain window can be configured, e.g., by a higher layer parameter. For instance, the higher layer parameter can be system information. For another instance, the higher layer parameter can be dedicated RRC parameter.

For yet another example, the locations (e.g., including a number of reception occasion) for the one or multiple reception occasion for the low power signal(s) within the time domain window can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For yet another example, the time period that the time domain windows are confined in can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

In another aspect, the time domain resources for the low power signal(s) can include at least one reception occasion, wherein the configuration of the at least one reception occasion can be indicated by a other signal or channel or the availability of the at least one reception occasion can be triggered by a other signal or channel.

For one example, the other signal or channel can be a PDCCH.

For another example, the other signal or channel can be a PDSCH.

For yet another example, the other signal or channel can be a SS/PBCH block.

For yet another example, the other signal or channel can be a CSI-RS.

For yet another example, the other signal or channel can be another low power signal (e.g., LP-SYNC for synchronization purpose).

In yet another aspect, the time domain resources for the low power signal(s) can include a number of OFDM symbols for the low power signal(s), e.g., for each transmission occasion.

For one example, for each type of the low power signal(s), the number of OFDM symbol within one transmission occasion can be fixed, e.g., as 1 or 14 or 28.

For another example, for each type of the low power signal(s), the number of OFDM symbol within one transmission occasion can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

In yet another aspect, the time domain resources for the low power signal(s) can include a number of repetitions for the low power signal(s), e.g., for each transmission occasion.

For one example, for each type of the low power signal(s), the number of repetitions for the low power signal(s) within one transmission occasion can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

In yet another aspect, the time domain resources for the low power signal(s) can include a number of transmission instances for the low power signal(s) within a burst of transmissions (e.g., number of beams within a burst of transmissions).

For one example, for each type of the low power signal(s), the number of transmission instances for the low power signal(s) within one transmission occasion can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

In one embodiment, the low power signal(s) can be multiplexed with other signal or channel in the time domain. For instance, the OFDM symbols including the low power signal(s) can be time division multiplexed (TDMed) with OFDM symbols including other signal or channel.

For one example, within a slot, the OFDM symbols including the low power signal(s) can be TDMed with OFDM symbols including other signal or channel.

For another example, within a slot, when the OFDM symbols including the low power signal(s) are TDMed with OFDM symbols including other signal or channel, there could be a guard time period between the OFDM symbols including the low power signal(s) and the OFDM symbols including other signal or channel. For instance, the guard time period can be fixed as 1 OFDM symbol. For another instance, the guard time period can be configured, e.g., by a higher layer parameter (system information or dedicated RRC parameter). For yet another instance, the value of the guard period can be subject to a UE capability. For yet another instance, the value of the guard period can be determined based on a subcarrier spacing of the other signal or channel, or a subcarrier spacing of the low power signal(s). For one further consideration, the other signal or channel can be limited to at least one of a PRACH (e.g., in a valid PRACH occasion) or PUSCH (e.g., in a valid PUSCH occasion).

For yet another example, within a slot, the OFDM symbols including the low power signal(s) cannot be TDMed with OFDM symbols including other signal or channel.

In one embodiment, power domain resources for the low power signal(s) (e.g., LP-WUS) can include at least one of the following aspects.

In one aspect, the power domain resources for the low power signal(s) can include a power offset between the low power signal(s) and a reference signal.

For one example, the reference signal can be SS/PBCH block.

For another example, the reference signal can be CSI-RS.

For one example, the power offset can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For another example, the power offset can be indicated, e.g., by a DCI format.

In another aspect, the power domain resources for the low power signal(s) can include an energy per resource element (EPRE) ratio between the low power signal(s) and a reference signal.

For one example, a UE may assume the EPRE ratio of the low power signal(s) to the EPRE of secondary synchronization signal (SSS) is a fixed value, e.g., 0 dB.

For another example, a UE may assume the EPRE ratio of the low power signal(s) to the EPRE of primary synchronization signal (PSS) is a fixed value, e.g., 0 dB.

For yet another example, a UE may assume the EPRE ratio of the low power signal(s) to the EPRE of demodulation reference signal (DM-RS) of PBCH is a fixed value, e.g., 0 dB.

For yet another example, a UE may assume the EPRE ratio of the low power signal(s) to the EPRE of CSI-RS is a fixed value, e.g., 0 dB.

For one example, a UE may assume the EPRE ratio of the low power signal(s) to the EPRE of SSS can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For another example, a UE may assume the EPRE ratio of the low power signal(s) to the EPRE of PSS can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For yet another example, a UE may assume the EPRE ratio of the low power signal(s) to the EPRE of DM-RS of PBCH can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For yet another example, a UE may assume the EPRE ratio of the low power signal(s) to the EPRE of CSI-RS can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For one example, a UE may assume the EPRE ratio of the low power signal(s) to the EPRE of SSS can be determined as 10*log 10(N_RB\hat{ }SSS/ N_RB\hat{ }LP), wherein N_RB\hat{ }SSS is the number of RBs/REs for SSS and N_RB\hat{ }LP is the number of RBs/REs for the low power signal(s) (e.g., may or may not include the guard band).

For another example, a UE may assume the EPRE ratio of the low power signal(s) to the EPRE of PSS can be determined as 10*log 10(N_RB\hat{ }PSS/ N_RB\hat{ }LP), wherein N_RB\hat{ }PSS is the number of RBs/REs for PSS and N_RB\hat{ }LP is the number of RBs/REs for the low power signal(s) (e.g., may or may not include the guard band).

For yet another example, a UE may assume the EPRE ratio of the low power signal(s) to the EPRE of DM-RS of PBCH can be determined as 10*log 10(N_RB\hat{ }DM-RS/ N_RB\hat{ }LP), wherein N_RB\hat{ }DM-RS is the number of RBs/REs for DM-RS of PBCH and N_RB\hat{ }LP is the number of RBs/REs for the low power signal(s) (e.g., may or may not include the guard band).

For yet another example, a UE may assume the EPRE ratio of the low power signal(s) to the EPRE of CSI-RS can be determined as 10*log 10(N_RB\hat{ }CSI-RS/ N_RB\hat{ }LP), wherein N_RB\hat{ }CSI-RS is the number of RBs/REs for CSI-RS and N_RB\hat{ }LP is the number of RBs/REs for the low power signal(s) (e.g., may or may not include the guard band).

In yet another aspect, the power domain resources for the low power signal(s) can include a parameter indicating the power level to be applied to the modulated sequence generated for the low power signal(s) (e.g., a parameter multiplied to the modulated sequence).

For one example, the parameter can be configured, e.g., by a higher layer parameter. For instance, the higher layer parameter can be system information (e.g., system information block 1, SIB1, or system information block X, SIBX, where X>1). For another instance, the higher layer parameter can be dedicated RRC parameter.

For another example, the parameter can be fixed, e.g., as 1.

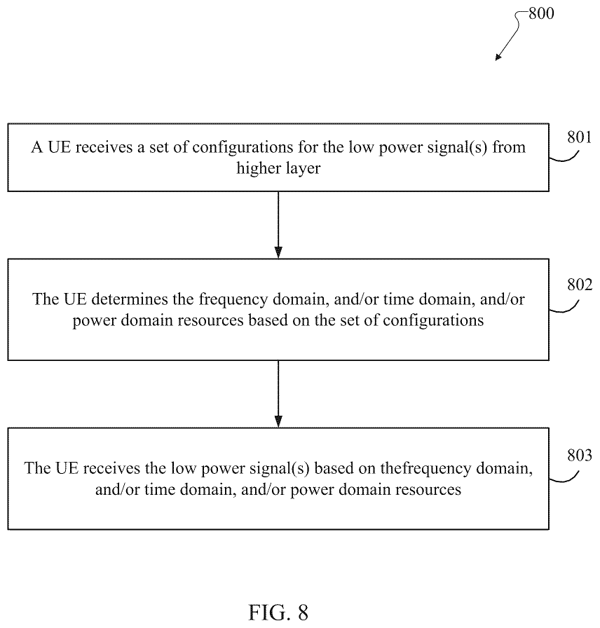

FIG. 8 illustrates a flowchart of an example UE procedure 800 for the low power signal(s) according to embodiments of the present disclosure. For example, procedure 800 for the low power signals can be performed by any of the UEs 111-116 of FIG. 1. This example is for illustration only and other embodiments can be used without departing from the scope of the present disclosure.

The procedure begins in 801, a UE receives a set of configurations for the low power signal(s) from a higher layer. In 802, the UE 116 then determines the frequency domain, and/or time domain, and/or power domain resources based on the set of configurations. In 803, the UE 116 then receives the low power signals based on the frequency domain, and/or time domain, and/or power domain resources.

In one embodiment, with reference to FIG. 8, an example UE procedure for using the resources for the low power signal(s) is shown.

In one embodiment, the parameter associated with the configuration for the low power signal(s) (e.g., time domain, and/or frequency domain, and/or power domain), as described in this disclosure, can be included in an UE assistance information, which is included in a RRC parameter transmitted from a UE to a gNB. A UE can report its preferred configuration parameter via the UE assistance information. UE assistance information can account for different environment conditions (e.g., urban vs. rural settings) or operational scenarios (e.g., stationary vs mobile state). Upon reception of the UE assistance information, the gNB may adjust the configuration parameter if needed.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive a first configuration for a discontinuous reception (DRX) of a low power signal; and
a processor operably coupled to the transceiver, the processor configured to determine, based on the first configuration for the DRX:
a duration of an ON period associated with the DRX;
a cycle period within which the ON period periodically occurs in time; and
a number of monitoring occasions for the low power signal within the ON period;
wherein the transceiver is further configured to receive the low power signal based on the monitoring occasions for the low power signal.

2. The UE of claim 1, wherein the first configuration for the DRX of the low power signal are included in at least one of a system information block and a dedicated radio resource control (RRC) parameter.

3. The UE of claim 1, wherein:
the transceiver is further configured to receive a second configuration for frequency domain information of the low power signal, and
the frequency domain information includes:
a subcarrier spacing of the low power signal; and
a frequency location of a resource block (RB) within RBs to which the low power signal is mapped.

4. The UE of claim 1, wherein:
the transceiver is further configured to receive a second configuration for power domain information of the low power signal, and
the power domain information includes a power offset for the low power signal with respect to a reference signal.

5. The UE of claim 1, wherein the processor is further configured to determine a predefined number of resource blocks (RBs) as a bandwidth for the low power signal and a guard band of the bandwidth.

6. The UE of claim 1, wherein:
the processor is further configured to:
determine a downlink (DL) channel overlapping with at least one resource element (RE) of the low power signal; and
determine to drop a reception of the DL channel; and
the DL channel is a physical downlink control channel (PDCCH) or a physical downlink shared channel (PDSCH).

7. The UE of claim 1, wherein:
the processor is further configured to:
determine a downlink (DL) channel overlapping with at least one resource element (RE) of the low power signal; and
determine to drop a reception of the low power signal; and
the DL channel is a synchronization signals and physical broadcast channel (SS/PBCH) block.

8. A base station (BS) in a wireless communication system, the BS comprising:
a processor configured to determine a first configuration for a discontinuous reception (DRX) of a low power signal, wherein the first configuration includes:
a duration of an ON period associated with the DRX;
a cycle period within which the ON period periodically occurs in time; and
a number of monitoring occasions for the low power signal within the ON period; and
a transceiver operably coupled to the processor, the transceiver configured to:
transmit the first configuration for the DRX of the low power signal; and
transmit the low power signal based on the first configuration.

9. The BS of claim 8, wherein the first configuration for the DRX of the low power signal are included in at least one of a system information block and a dedicated radio resource control (RRC) parameter.

10. The BS of claim 8, wherein:
the transceiver is further configured to transmit a second configuration for frequency domain information of the low power signal, and
the frequency domain information includes:
a subcarrier spacing of the low power signal; and
a frequency location of a resource block (RB) within RBs to which the low power signal is mapped.

11. The BS of claim 8, wherein:
the transceiver is further configured to transmit a second configuration for power domain information of the low power signal, and
the power domain information includes a power offset for the low power signal with respect to a reference signal.

12. The BS of claim 8, wherein the processor is further configured to determine a predefined number of resource blocks (RBs) as a bandwidth for the low power signal and a guard band of the bandwidth.

13. The BS of claim 8, wherein:
the processor is further configured to:
determine a downlink (DL) channel overlapping with at least one resource element (RE) of the low power signal; and
determine to drop a transmission of the DL channel; and
the DL channel is a physical downlink control channel (PDCCH) or a physical downlink shared channel (PDSCH).

14. The BS of claim 8, wherein:
the processor is further configured to:
determine a downlink (DL) channel overlapping with at least one resource element (RE) of the low power signal; and
determine to drop a transmission of the low power signal; and
the DL channel is a synchronization signals and physical broadcast channel (SS/PBCH) block.

15. A method of a user equipment (UE) in a wireless communication system, the method comprising:
receiving a first configuration for a discontinuous reception (DRX) of a low power signal;
determining, based on the first configuration for the DRX:
a duration of an ON period associated with the DRX;
a cycle period within which the ON period periodically occurs in time; and
a number of monitoring occasions for the low power signal within the ON period; and
receiving the low power signal based on the monitoring occasions for the low power signal.

16. The method of claim 15, wherein the first configuration for the DRX of the low power signal are included in at least one of a system information block and a dedicated radio resource control (RRC) parameter.

17. The method of claim 15 further comprising:
receiving a second configuration for frequency domain information of the low power signal,
wherein the frequency domain information includes:
a subcarrier spacing of the low power signal; and
a frequency location of a resource block (RB) within RBs that the low power signal is mapped to.

18. The method of claim 15 further comprising:
receiving a second configuration for power domain information of the low power signal,
wherein the power domain information includes a power offset for the low power signal with respect to a reference signal.

19. The method of claim 15 further comprising determining a predefined number of resource blocks (RBs) as a bandwidth for the low power signal and a guard band of the bandwidth.

20. The method of claim 15 further comprising:
determining a first downlink (DL) channel overlapping with at least one resource element (RE) of the low power signal;
determining to drop a reception of the first DL channel;
determining a second DL channel overlapping with at least one RE of the low power signal; and
determining to drop a reception of the low power signal,
wherein the first DL channel is a physical downlink control channel (PDCCH) or a physical downlink shared channel (PDSCH), and
wherein the second DL channel is a synchronization signals and physical broadcast channel (SS/PBCH) block.
